(19) United States
(12) Patent Application Publication
(10) Pub. No.: US 2018/0155236 A1
(43) Pub. Date: Jun. 7, 2018

(54) LIGHT-SCATTERING GLASS ARTICLES AND METHODS FOR THE PRODUCTION THEREOF

(71) Applicant: CORNING INCORPORATED, CORNING, NY (US)

(72) Inventors: Megan Aurora DeLamielleure, Corning, NY (US); Paul Bennett Dohn, Corning, NY (US); Timothy James Kiczenski, Corning, NY (US); Irene Mona Peterson, Elmira Heights, NY (US); Robert Anthony Schaut, Painted Post, NY (US); Elizabeth Mary Sturdevant, Corning, NY (US); Natesan Venkataraman, Painted Post, NY (US)

(21) Appl. No.: 15/578,055

(22) PCT Filed: Jun. 1, 2016
(86) PCT No.: PCT/US16/35235

§ 371 Date: Nov. 29, 2017

Related U.S. Application Data
(60) Provisional application No. 62/169,939, filed on Jun. 2, 2015.

(51) Int. Cl. C03C 14/00; C03B 17/02; C03B 17/06; B32B 17/10

(52) U.S. Cl. CPC C03C 14/006; C03B 17/02; C03B 17/064; B32B 2307/418; C03C 2214/16; C03C 2214/30; B32B 17/10036

(57) ABSTRACT

According to embodiments disclosed herein, light-scattering laminated glass articles may include a first glass layer, a second glass layer, and a light-scattering component. The first glass layer may be formed from a first glass composition. The second glass layer may be formed from a second glass composition and fused to the first glass layer. The light-scattering component may be disposed at an interface of the first glass layer and the second glass layer. The light-scattering component may include a different composition or material phase than the first glass layer and the second glass layer. Also disclosed herein are methods for producing light-scattering laminated glass articles.

This application claims the benefit of priority to U.S. Application No. 62/169,939, filed Jun. 2, 2015, the content of which is incorporated herein by reference in its entirety.

### BACKGROUND

### Field

The present specification generally relates to glass articles and, more specifically, to glass articles with light-scattering properties and methods for the production thereof.

### Technical Background

Glass articles, such as cover glasses, glass backplanes and the like, are employed in both consumer and commercial electronic devices such as LCD and LED displays, computer monitors, automated teller machines (ATMs), and the like. Some of these glass articles may include “touch” functionality which necessitates that the glass article be contacted by various objects including a user's fingers and/or stylus devices and, as such, the glass must be sufficiently robust to endure regular contact without damage. Moreover, such glass articles may also be incorporated in portable electronic devices, such as mobile telephones, personal media players, and tablet computers. The glass articles incorporated in these devices may be susceptible to damage during transport and/or use of the associated device. Accordingly, glass articles used in electronic devices may require enhanced strength to be able to withstand not only routine “touch” contact from actual use, but also incidental contact and impacts which may occur when the device is being transported.

Various processes may be used to strengthen glass articles, including chemical tempering, thermal tempering, and lamination. A glass article strengthened by lamination is formed from at least two glass compositions which have different coefficients of thermal expansion. These glass compositions are brought into contact with one another in a molten state to form the glass article and fuse or laminate the glass compositions together. As the glass compositions cool, the difference in the coefficients of thermal expansion cause compressive stresses to develop in at least one of the layers of glass, thereby strengthening the glass article. Lamination processes can also be used to impart or enhance other properties of laminated glass articles, including physical, optical, and chemical properties.

However, laminated glass sheets may not have desirable optical characteristics for applications such as cover glasses, glass backplanes, and the like, used in display devices, especially when viewing an image at non-normal angles is a consideration for a particular display device application. Accordingly, a need exists for alternative laminated glass articles and methods for forming laminated glass articles which have improved optical characteristics.

### SUMMARY

According to one embodiment, a light-scattering laminated glass article may comprise a first glass layer, a second glass layer, and a light-scattering component. The first glass layer may be formed from a first glass composition The second glass layer may be formed from a second glass composition and fused to the first glass layer. The light-scattering component may be disposed at an interface of the first glass layer and the second glass layer The light-scattering component may comprise a different composition or material phase than the first glass layer and the second glass layer.

In another embodiment, a light-scattering laminated glass article may be produced. The method for production may comprise flowing a molten first glass composition and flowing a molten second glass composition. The method may also comprise depositing a plurality of light-scattering particles onto a surface of the molten first glass composition or a surface of the molten second glass composition. The method may also comprise contacting the molten first glass composition with the molten second glass composition to form an interface between the molten first glass composition and the molten second glass composition. The plurality of light-scattering particles may be located at the interface between the molten first glass composition and the molten second glass composition.

In yet another embodiment, a light-scattering laminated glass article may be produced. The method for production may comprise flowing a molten first glass composition and flowing a molten second glass composition. The method may also comprise contacting the molten first glass composition with the molten second glass composition to form an interface between the molten first glass composition and the molten second glass composition. The method may also comprise producing a plurality of light-scattering gas pockets at the interface between the molten first glass composition and the molten second glass composition.

In yet another embodiment, a light-scattering laminated glass article may be produced. The method for production may comprise flowing a molten first glass composition and flowing a molten second glass composition. The method may also comprise contacting the molten first glass composition with the molten second glass composition to form an interface between the molten first glass composition and the molten second glass composition. The method may also comprise producing a light-scattering component comprising one or more crystalline or semi-crystalline bodies positioned at the interface between the molten first glass composition and the molten second glass composition.

Additional features and advantages of the glass articles and methods described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts a cross-sectional view of a portion of a laminated glass article, according to one or more embodiments shown and described herein;

FIG. 2 schematically depicts a magnified cross-sectional view of a portion of an interface of glass layers in the laminated glass article of FIG. 1, according to one or more embodiments shown and described herein;

FIG. 3 schematically depicts a fusion draw process for making the glass article of FIG. 1, according to one or more embodiments shown and described herein;

FIG. 4 schematically depicts a fusion draw process including a particle delivery device for making the glass article of FIG. 1, according to one or more embodiments shown and described herein; and

FIG. 5 graphically depicts the liquidus temperatures of materials formed from the mixture of the glass compositions of Table 1, according to one or more embodiments shown and described herein.

### DETAILED DESCRIPTION

Reference will now be made in detail to embodiments of laminated glass articles comprising light-scatting components, and methods for producing laminated glass articles comprising light-scattering components, examples of which are illustrated in the accompanying drawings. Whenever possible, the same reference numerals will be used throughout the drawings to refer to the same or like parts. Generally described herein are laminated glass articles comprising light-scattering components. The light-scattering components may enhance the optical characteristics of the laminated glass article, such as when the laminated glass article is utilized in a display device for viewing images, including still-images or video. For example, an image may be projected on to the laminated glass article (e.g., from a front or back side relative to a viewer). The light scattering components may scatter the projected image so that it is viewable by the viewer. Thus, the light scattering components enable the laminated glass article to be used as a projection screen (e.g., a transparent projection screen). Also for example, light from a display device may propagate through the laminated glass article utilized as a cover glass (i.e., towards the viewer) and the image may be enhanced by scattering the light into varying directions as the light exits the laminated glass article. In particular, image quality at non-normal viewing angles may be enhanced by the light-scattering function of the laminated glass article. That is, light entering the laminated glass article at an angle substantially normal to a major surface of the laminated glass article can be scattered to enhance the image at non-normal viewing angles.

One embodiment of a light-scattering laminated glass article comprises a light-scattering component disposed at the interface of a first glass layer and a second glass layer of the laminated glass article. Generally, the light-scattering component may comprise a material having a chemical composition and/or phase which is different from the chemical composition and/or phase of the first glass layer and the second glass layer. A variety of light-scattering components are described herein where, generally, the light-scattering component serves to scatter light which is projected onto or through the laminated glass article. The light-scattering may be accomplished by a difference in refractive index of the light-scattering component as compared with the materials of the first glass layer and the second glass layer, or may be accomplished by at least the partial reflectivity of the light-scattering component. In some embodiments, the light-scattering component may comprise one or more light-scattering members. Generally, the light-scattering members may range in size from about 100 nm to about 1 micron, and a distribution of varying sized light-scattering members may be disposed in a single laminated glass article. In other embodiments, the light-scattering component may comprise a layer that has a composition derived from the combination of the two glass compositions at the lamination interface. The laminated glass articles described herein promote light-scattering while having smooth outer edges and surfaces, since the light-scattering members are embedded within the laminated glass.

Described herein are a variety of physical embodiments of light-scattering components including, without limitation, refractory particles, gas pockets, and crystalline or semi-crystalline bodies. Also described herein are a variety of methods for producing such light-scattering components in a laminated glass article including, without limitation, inserting light-scattering particles into the laminated glass article, blistering the laminated glass article, and/or forming one or more crystalline or semi-crystalline bodies in the laminated glass article. These embodiments will be described in greater detail herein.

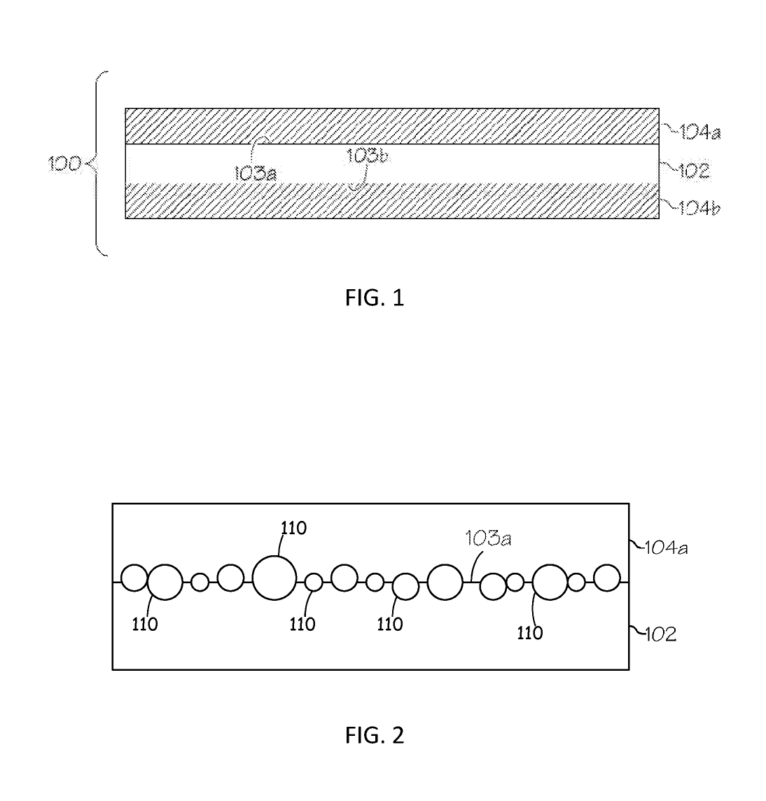

Referring now to FIG. 1, a cross-sectional view of a laminated glass article 100 is schematically depicted. The laminated glass article 100 generally comprises a glass core layer 102 and at least one glass cladding layer 104a. In the embodiment of the laminated glass article 100 shown in FIG. 1, the laminated glass article comprises a pair of glass cladding layers 104a, 104b positioned on either side of the glass core layer 102. Alternatively, the laminated glass article 100 may be constructed as a bi-layer laminate, such as when one of the glass cladding layers 104a, 104b is omitted from the laminated glass article leaving a single glass cladding layer fused to the glass core layer. In other embodiments, more than three glass layers may be laminated with one another, such as 3, 4, 5, 6, or even more.

While FIG. 1 schematically depicts the laminated glass article 100 as being a laminated glass sheet, it should be understood that other configurations and form factors are contemplated and possible. For example, the laminated glass article may have a non-planar configuration such as a curved glass sheet or the like. Alternatively, the laminated glass article may be a laminated glass tube, container, or the like.

Still referring to FIG. 1, the glass core layer 102 generally comprises a first surface 103a and a second surface 103b which is opposed to the first surface 103a. A first glass cladding layer 104a is fused to the first surface 103a of the glass core layer 102 and a second glass cladding layer 104b is fused to the second surface 103b of the glass core layer 102. Thus, the glass cladding layers 104a, 104b are fused directly to the glass core layer 102 or are directly adjacent to the glass core layer. Lamination interfaces are present at the first surface 103a and the second surface 103b. As used herein, the “interface” refers to the meeting point of the glass core layer 102 and a glass cladding layer 104a and/or 104b and may comprise a diffusion layer formed between the glass core layer and a glass cladding layer (e.g., formed by inter-diffusion between the two adjacent glass layers).

Now referring to FIG. 2, in embodiments, the laminated glass article 100 comprises a light-scattering component comprising light-scattering members 110 disposed between the glass core layer 102 and at least one of the glass cladding layers 104a, 104b (i.e., at the interface). The light-scattering members 110 may be positioned along substantially the entire interface of the glass core layer 102 and the glass cladding layer 104a. As depicted in FIG. 2, the light-scattering members 110 may be substantially spherical in shape. However, in other embodiments, the light-scattering members 110 may have other shapes or form factors, such as irregularly shaped bodies having rounded or substantially flat surfaces, including particles comprising sharp angular features. The light-scattering members 110 may have varying sizes. In one embodiment, each light-scattering member 110 may have a maximum dimension of from about 100 nm to about 1 micron (such as from about 100 nm to about 900 nm, from about 100 nm to about 800 nm, from about 100 nm to about 700 nm, from about 100 nm to about 600 nm, from about 100 nm to about 500 nm, from about 100 nm to about 400 nm, from about 100 nm to about 300 nm, from about 100 nm to about 200 nm, from about 200 nm to about 1 micron, from about 300 nm to about 1 micron, from about 400 nm to about 1 micron, from about 500 nm to about 1 micron, from about 600 nm to about 1 micron, from about 700 nm to about 1 micron, from about 800 nm to about 1 micron, or from about 900 nm to about 1 micron). However, other embodiments are contemplated herein that utilize light-scattering members 110 which have a maximum dimension even greater than 1 micron. As used herein, the “maximum dimension” refers to the greatest distance between surfaces of an individual light-scattering member 110 through the light-scattering member 110. For example, the maximum dimension of a spherical light-scattering member 110 is the diameter of the sphere. The “average maximum dimension” refers to the average of the maximum dimensions of all light-scattering members 110 of a laminated glass article 100.

The light-scattering members 110 may comprise a composition or phase different from the other portions of the laminated glass article 100. In embodiments, the light-scattering members 110 may comprise solids and/or gasses, or may comprise void spaces. It should further be understood that some of the light-scattering members 110 may have different compositions or phases from one another.

In another embodiment, the light-scattering component may be a substantially flat interlayer at the lamination interface. The interlayer may be formed from the inter-diffusion of the glass core layer 102 and one or more of the glass cladding layers 104a, 104b. The interlayer formed is situated at the interface of the glass core layer 102 and one or more of the glass cladding layers 104a, 104b The interlayer may be thin (i.e., less than about 1 micron, less than about 900 nm, less than about 800 nm, less than about 700 nm, less than about 600 nm, less than about 500 nm, less than about 400 nm, less than about 300 nm, or less than about 200 nm). In some embodiments, an interlayer may comprise light-scattering members 110 while, in other embodiments, individual light-scattering members may not be distinguishable within the bulk of the interlayer. For example, crystal growth may be present throughout the interlayer and individual nucleation sites for crystallization growth may create light-scattering members within the interlayer.

The light-scattering members 110 may have varying sizes and shapes, such that they interact differently with light of different wavelengths. Such varying sizes and/or shapes can enable an image comprising a plurality of colors (e.g., a full color image) to be projected onto the laminated glass article and visible by the viewer. In one embodiment, light-scattering members have a size distribution suitable to scatter light over a portion of or substantially the entire visible spectrum (i.e., light within the range from about 400 nm to about 700 nm). The amount of light-scattering particles may vary per surface area of the interface. However, it should be understood that the methods for producing laminated glass articles as described herein may be capable of controlling the size, shape, size distribution, and/or relative amount of the light-scattering members.

The material of the light-scattering component may have a refractive index that is different from the materials of the glass core layer 102 and glass cladding layers 104a, 104b. For example, the refractive index of the material of the light-scattering component may be at least about 1%, at least about 2%, at least about 3%, at least about 4%, at least about 5%, at least about 10%, at least about 20%, at least about 30%, at least about 40%, or even at least about 50% different (i.e., greater than or less than) than the refractive index of the materials of the glass core layer 102 and/or the glass cladding layers 104a, 104b.

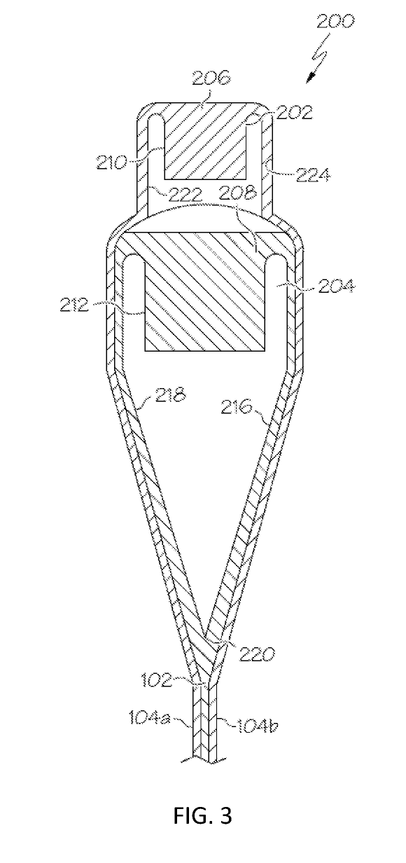

In one embodiment, the laminated glass articles 100 described herein may be formed by a fusion lamination process such as the process described in U.S. Pat. No. 4,214,886, which is incorporated herein by reference. Referring to FIG. 3 by way of example, a laminate fusion draw apparatus 200 for forming a laminated glass article includes an upper overflow distributor or isopipe 202 which is positioned over a lower overflow distributor or isopipe 204. The upper overflow distributor 202 includes a trough 210 into which a molten glass cladding composition 206 is fed from a melter (not shown). Similarly, the lower overflow distributor 204 includes a trough 212 into which a molten glass core composition 208 is fed from a melter (not shown). In embodiments, the molten glass cladding composition 206 may be a first glass composition and the molten glass core composition may be a second glass composition, where the first glass composition and the second glass composition are different from one another.

As the molten glass core composition 208 fills the trough 212, it overflows the trough 212 and flows over the outer forming surfaces 216, 218 of the lower overflow distributor 204. The outer forming surfaces 216, 218 of the lower overflow distributor 204 converge at a root 220. Accordingly, the molten glass core composition 208 flowing over the outer forming surfaces 216, 218 rejoins at the root 220 of the lower overflow distributor 204 thereby forming a glass core layer 102 of a laminated glass article.

Simultaneously, the molten glass cladding compositions 206 overflows the trough 210 formed in the upper overflow distributor 202 and flows over outer forming surfaces 222, 224 of the upper overflow distributor 202. The molten glass cladding composition 206 is outwardly deflected by the upper overflow distributor 202 such that the molten glass cladding composition 206 flows around the lower overflow distributor 204 and contacts the molten glass core composition 208 flowing over the outer forming surfaces 216, 218 of the lower overflow distributor, fusing to the molten glass core composition and forming glass cladding layers 104a, 104b around the glass core layer 102.

In some embodiments, the molten glass core composition 208 may have an average core coefficient of thermal expansion CTE_{core} which is greater than the average cladding coefficient of thermal expansion CTE_{clad} of the molten glass cladding composition 206. Accordingly, as the glass core layer 102 and the glass cladding layers 104a, 104b cool, the difference in the coefficients of thermal expansion of the glass core layer 102 and the glass cladding layers 104a, 104b cause a compressive stresses to develop in the glass cladding layers 104a, 104b. The compressive stress increases the strength of the resulting laminated glass article. As used herein, the term “average coefficient of thermal expansion” refers to the average coefficient of thermal expansion of a given material or layer between 0° C. and 300° C.

In some embodiments, CTE_{core} and CTE_{clad} differ by at least about 5×10⁻⁷° C.⁻¹, at least about 15×10⁻⁷° C.⁻¹, at least about 25×10⁻⁷° C.⁻¹, or at least about 30×10⁻⁷° C.⁻¹. Additionally, or alternatively, CTE_{core} and CTE_{clad} differ by at most about 100×10⁻⁷° C.⁻¹, at most about 75×10⁻⁷° C.⁻¹, at most about 50×10⁻⁷° C.⁻¹, at most about 40×10⁻⁷° C.⁻¹, at most about 30×10⁻⁷° C.⁻¹, at most about 20×10⁻⁷° C.⁻¹, or at most about 10×10⁻⁷° C.⁻¹. In some embodiments, CTE_{clad} is at most about 66×10⁻⁷° C.⁻¹, at most about 55×10⁻⁷° C.⁻¹, at most about 50×10⁻⁷° C.⁻¹, at most about 40×10⁻⁷° C.⁻¹, or at most about 35×10⁻⁷° C.⁻¹. Additionally, or alternatively, CTE_{clad} is at least about 25×10⁻⁷° C.⁻¹, or at least about 30×10⁻⁷° C.⁻¹. Additionally, or alternatively, CTE_{core} is at least about 40×10⁻⁷° C.⁻¹, at least about 50×10⁻⁷° C.⁻¹, at least about 55×10⁻⁷° C.⁻¹, at least about 65×10⁻⁷° C.⁻¹, at least about 70×10⁻⁷° C.⁻¹, at least about 80×10⁻⁷° C.⁻¹, or at least about 90×10⁻⁷° C.⁻¹. Additionally, or alternatively, CTE_{core} is at most about 110×10⁻⁷° C.⁻¹, at most about 100×10⁻⁷° C.⁻¹, at most about 90×10⁻⁷° C.⁻¹, at most about 75×10⁻⁷° C.⁻¹, or at most about 70×10⁻⁷° C.⁻¹.

While FIG. 3 schematically depicts a particular apparatus for forming laminated glass articles, it should be appreciated that other processes and apparatus are possible. For example, laminated glass articles can be formed using a slot draw, float, or other glass forming process. While FIG. 3 schematically depicts a particular apparatus for forming planar laminated glass articles such as sheets or ribbons, it should be appreciated that other geometrical configurations are possible. For example, cylindrical laminated glass articles may be formed, for example, using the apparatuses and methods described in U.S. Pat. No. 4,023,953.

In one embodiment, light-scattering members 110 may comprise particles positioned between the glass core layer 102 and the glass cladding layers 104a, 104b, as described above. These particles may have an average maximum dimension of from about 100 nm to about 1 micron (such as from about 100 nm to about 900 nm, from about 100 nm to about 800 nm, from about 100 nm to about 700 nm, from about 100 nm to about 600 nm, from about 100 nm to about 500 nm, from about 100 nm to about 400 nm, from about 100 nm to about 300 nm, from about 100 nm to about 200 nm, from about 200 nm to about 1 micron, from about 300 nm to about 1 micron, from about 400 nm to about 1 micron, from about 500 nm to about 1 micron, from about 600 nm to about 1 micron, from about 700 nm to about 1 micron, from about 800 nm to about 1 micron, or from about 900 nm to about 1 micron). In this embodiment, the particles may comprise a refractory material that does not melt or otherwise materially degrade when exposed to temperatures in the range of the softening or melting point of the glass compositions of the laminated glass article 100. For example, when the laminate fusion draw apparatus 200 is utilized, the particles may have a melting point greater than any operational temperature utilized in the laminate fusion draw apparatus 200. For example, the materials of the light-scattering particles may have melting points of at least about 1100° C., 1150° C., 1200° C., 1250° C., 1300° C., 1350° C., 1400° C., or even at least about 1450° C. In other embodiments, the light-scattering particles may at least partially melt and/or chemically react with the glass at high temperature to from light-scattering bodies. In embodiments, the light scattering particles may include an inorganic material, an organic material (e.g., an organometallic material), or combinations thereof. For example, the light-scattering particles may comprise, without limitation, silicon carbide, zirconia, alumina, silica, titania, niobium pentoxide, lanthanum oxide, silicon nitride, or combinations thereof. In one embodiment, the particles may be at least partially transparent and comprise a refractive index that is different from the material of the glass core layer 102 and the glass cladding layer or layers 104a, 104b. In another embodiment, the light-scattering particles may at least partially reflect light so as to scatter it in different directions.

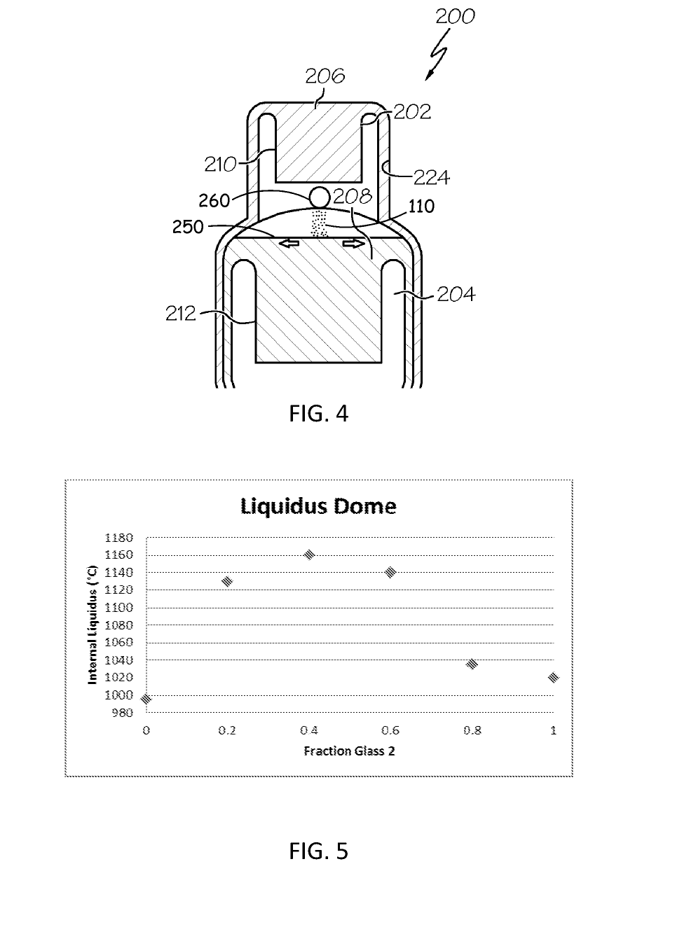

The light-scattering particles may be deposited at the interface between the molten glass core composition 208 and the molten glass cladding composition 206 in the laminated fusion draw process depicted in FIG. 3. In one embodiment, depicted in FIG. 4, light-scattering members 110 are introduced onto the top surface 250 of the molten glass core composition 208 before the molten glass core composition contacts the molten glass cladding composition 206. For example, the light-scattering members 110, particles in some embodiments, are dropped from a channel 260 formed in the upper isopipe 202. The arrows of FIG. 4 generally depict the fluid flow of the molten glass core composition 208, showing that the particles generally remain on the upper surface 250 and are transported into the interface of the glass layers. In embodiments, the channel 260 may comprise a pipe or screw feeder to transport particles into the channel. The bottom of the channel 260 may comprise periodically placed orifices to allow the particles to be transported onto the upper surface 250 of the molten glass core composition 208. In embodiments, the particles may be pre-agglomerated or coated to control agglomeration of particles which could potentially build inside of the channel 260. It should be understood that any suitable method for mechanically depositing the particles at the interface is acceptable. For example, the particles may be deposited by blowing or spraying the particles onto the molten glass core composition and/or the molten glass cladding composition.

In another embodiment, the particles may be inserted during the melt process of the molten glass core composition 208 or the molten glass cladding composition 206 at particular locations that enable the particles to be disposed at the interface of the laminated glass layers when processed by a laminate fusion draw process. The melted glass compositions generally flow in a laminar pattern, and as such, the melted glass that will be positioned at the lamination interface can be tracked throughout a downdraw lamination process. The final location of the particles may be predicted, such as by a predictive mapping tool which may predict the location of a particle in the glass through the laminar molten glass flow characterized by the melting process, which may allow for proper placement of the particles in the melts to be later positioned, by the molten glass' flow, to the lamination interface.

In another embodiment, the light-scattering members 110 may comprise gas pockets or voids disposed at the interface of the glass core layer 104 and one or more of the glass cladding layers 104a, 104b. Specifically, when two different glass compositions are joined together in the viscous or molten state to form a laminate structure, gas pockets (sometimes referred to as blisters) may form in one of the glass compositions adjacent to the interface between the two different glass compositions. The blisters or gas pockets may comprise oxygen, or other gases alone or mixed with oxygen, and may be formed in the viscous or molten glass during the fusion process. As the glass cools and solidifies, the gas pocket remains. As used herein, blistering refers to the formation of gas pockets at the lamination interface of the glass article.

Referring to the blistering process, the composition of the glass core layer 102 and the glass cladding layers 104a, 104b may be different to achieve different attributes in the final article, such as strengthening by a compressive stress arising from thermal expansion mismatch as described above, or particular optical or chemical properties that may be desirable in only one of the glass layers. For example, it may be desirable that one of the glass layers be crystallizable, have certain solubility, or even a specific color, different than the glass layer to which it is fused. Achieving these properties may require the addition of mobile elements, such as alkali cations, that are initially added to the glass composition as oxide constituents. These ions impart specific physical and/or chemical characteristics to the glass composition to which they are added. However, due to their relatively high mobility in the glass, these cations can diffuse across the interfaces between glass core layer 102 and the glass cladding layers 104a, 104b. As these cations diffuse across the interface, anions, such as oxygen anions, remain in the network but are no longer compensated or balanced by the cations. This changes the solubility of the anions in the network and may cause the anions to come out of solution and form gas pockets, for example, containing oxygen. These gas pockets may form after the molten glass cladding composition 206 and the molten glass core composition 208 come into contact at temperatures above the glass transition temperature T_{g}. It is believed that the gas pockets may be caused by the diffusion of cations, such as, for example, K+ cations, across the interface from the glass core layer 102 to the glass cladding layers 104a, 104b, or vice versa, which leaves uncompensated network oxygen behind in the glass core layer 102 or the glass cladding layers 104a, 104b.

More specifically, the migration of cations, such as K+ ions, between the glass core layer 102 and the glass cladding layers 104a, 104b leaves behind uncompensated oxygen anions which form the gas pockets, specifically oxygen bubbles. The formation of the oxygen bubble in the laminated glass article 100 is represented by the following equation:

O²→½O₂+2e−

Particular glass compositions for the molten glass cladding compositions 206 and/or the molten glass core composition 208 may be used to promote blistering. For example, the diffusion of potassium, iron, tin, or other ions may cause blistering, and glass compositions which include amounts of potassium, iron, and/or tin may be utilized.

In embodiments, glass blistering may occur under normal lamination processing conditions. However, some processing methods may be utilized to promote blistering to create the gas pockets. For example, in one embodiment, a reduced amount or total elimination of fining agents in the glass core layer 102 and/or the glass cladding layers 104a, 104b may promote blistering. Fining agents which are normally utilized to reduce the formation of blistering may be reduced or eliminated. For example, many fusion manufacturing processes employ arsenic as a fining agent. Arsenic is among the highest temperature fining agents known, and, when added to the molten glass bath, it allows for O₂ release from the glass melt at high melting temperatures (e.g., above 1450° C.). This high temperature O₂ release, which aids in the removal of bubbles during the melting and fining stages of glass production, coupled with a strong tendency for O₂ absorption at lower conditioning temperatures (which aids in the collapse of any residual gaseous inclusions in the glass), results in a glass product essentially free of gaseous inclusions. However, the removal or a decreased presence of fining agents such as arsenic may result in enhanced and controllable amount of blistering.

In another embodiment, environmental conditions surrounding the laminate fusion draw apparatus 200 maybe adjusted to promote blistering. In one embodiment, air may be blown on a surface of the molten glass core composition 208 and/or the molten glass cladding compositions 206 where the laminate interface will be formed.

In another embodiment, the partial pressure of hydrogen may be reduced in the environment around the laminate fusion draw apparatus 200. The low partial pressure may increase the diffusion of hydrogen from the molten glass cladding composition 206 and/or the molten glass core composition 208 through refractory materials which are incorporated into the laminate fusion draw apparatus, such as transport tubing majorly comprising platinum or platinum alloys. Many of the glasses manufactured by fusion lamination processes are melted or formed using components made from refractory metals, e.g. platinum or platinum alloys. This is particularly true in the fining and conditioning sections of the process, where refractory metals are employed to minimize the creation of compositional inhomogeneities and gaseous inclusions caused by contact of the glass with oxide refractory materials. Glass blistering may occur when hydrogen migrates from the glass and through the platinum. In one embodiment, glass blistering is promoted or controlled by utilizing a relatively low partial pressure of hydrogen outside around the platinum, thus promoting the diffusion of hydrogen through the platinum body.

In another embodiment, the molten glass cladding composition 206 and/or the molten glass core composition 208 is exposed to an electric potential. Such electric potential of the molten glass cladding composition 206 and/or the molten glass core composition 208 may promote controllable glass blistering at the area which will form the interface of the glass layers 102, 104a, 104b. The blistering may occur at an interface of the molten glass and a portion of the laminate fusion draw apparatus, including portions of the delivery apparatus not depicted in FIG. 3, such as platinum piping used to transport and melt the glass prior to its deposition into an isopipe. In such an embodiment, light-scattering members 101 could be tuned by utilizing a particular direct current potential and controllable patterns of light-scattering members could be created by adjusting the electrical characteristics. In one embodiment, charged platinum bodies, such as those utilized in the transfer mechanisms of a fusion draw process may be utilized as surfaces upon which glass blistering occurs. The blistered areas of the molten glass cladding composition 206 and/or the molten glass core composition 208 which contact the platinum bodies may become the lamination interface of the glass articles 100. Without being bound by theory, it is believed that the charged components of the laminate fusion draw apparatus 200 may promote electrons to flow out of the glass compositions, which may form oxygen pockets in the glass. For example, a positive potential on a platinum body of the laminate fusion draw apparatus will attract electrons from the glass. The oxygen pockets may eventually be positioned at the lamination interfaces and serve as light-scattering members 110.

In another embodiment, additional platinum bodies may be incorporated into the laminate fusion draw apparatus 200 or a platinum layer may be deposited onto a portion of the laminate fusion draw apparatus 200. For example, a portion of the upper isopipe 202 may be platinum coated and in contact with the molten glass cladding composition 206. The platinum coating may have a potential difference relative to the molten glass cladding composition 206, which promotes blistering and the formation of gas pockets. For example the lip at the top of the upper isopipe 202 may be charged with a positive potential, causing blistering on the surface of the molten glass cladding composition which forms the lamination interface. In another embodiment, a conductive rod, such as constructed from platinum or alloys of platinum, may be positioned to contact the top surface of the molten glass core composition 208 that is situated in the lower isopipe 204. The platinum rod may promote blistering on the top surface of the molten glass core composition, which becomes the lamination interface when contacted with the molten glass cladding composition 206.

In another embodiment, the light-scattering component may comprise one or more crystalline, semi-crystalline, or phase separated bodies disposed at the interface of the glass core layer 14 and one or more of the glass cladding layers 104a, 104b. The crystalline, semi-crystalline, or phase separated bodies may form discrete light-scattering members 110, as depicted in FIG. 2, or may be formed in a uniform layer at the interface of the laminated glass layers. The crystalline, semi-crystalline, or phase separated bodies may be caused by the inter-diffusion of materials present in the molten glass cladding compositions 206 and the molten glass core composition 208. In embodiments, the crystalline, semi-crystalline, or phase separated bodies may comprise ceramic or glass-ceramic materials. The crystalline or semi-crystalline bodies described herein may be at least partially devitrified, meaning that at least some degree of organized internal structure is associated with the crystalline or semi-crystalline bodies. Phase separated materials may have a phase (e.g., an amorphous phase or glass phase) which is different from the surrounding glass composition.

In various embodiments, the light-scattering component can be present at locations other than the interface between the core layer and the cladding layers. For example, a layer of the glass article (e.g., the core layer or the cladding layer) can be phase separated to form the light scattering component. Such a glass article with a phase separated layer, with or without additional light-scattering members at the core/clad interface) can be used, for example, as a transparent projection screen. In other embodiments, the light-scattering component can be restricted to the interface between the core layer and the cladding layers. For example, the core layer and/or the cladding layer can be substantially free of light-scattering members at outer surfaces thereof, remote from the interface.

In one embodiment, nucleation sites may be generated during the fusion lamination process due to the fusing of the two glasses at high temperatures. The nucleation sites may allow devitrification at the interfaces of the glass core layer 102 and the glass cladding layers 104a, 104b. Devitrification may occur during the fusion process or in one or more subsequent heat treatments following formation of the glass laminate.

In one embodiment, to form the crystalline or semi-crystalline bodies, materials at the interface of the glass core layer 102 and/or the glass cladding layers 104a, 104b form an interlayer comprising an intermixed composition which is crystallizable. The intermixed composition may be crystallized by heating which may occur while the glass is being laminated in the fusion draw process. In other embodiments, additional heat treatments may be used to crystallize the intermixed composition after formation of the glass laminate. Additionally, heat treatments may be used to form the intermixed composition, where the heat treatment promotes diffusion and mixing of the components of the glass core layer 102 and the glass cladding layers 104a, 104b at the interface. For example, a first heat treatment may serve to form the intermixed composition and a second heat treatment may at least partially crystallize the intermixed composition. In another embodiment, an electrical potential in the molten glass cladding composition 206 and/or the molten glass core composition 208 may be utilized to form the intermixed composition.

In one embodiment, the intermixed composition of the interlayer may have a higher liquidus temperature than the materials of glass core layer 102 and the glass cladding layers 104a, 104b. For example, the liquidus temperature of the intermixed composition of the interlayer may be at least about 10% higher, at least about 20% higher, at least about 30% higher, at least about 40% higher, or even at least about 50% higher than the liquidus temperature of glass core layer 102 and/or the glass cladding layers 104a, 104b Without being bound by theory, it is believed that relatively high liquidus temperature of the intermixed composition allows for the intermixed composition to be devitrified and/or phase separated in subsequent heating steps, or even during the fusion lamination process. In one embodiment, the intermixed composition may have a devitrification temperature in the range of the forming temperature of the glass core layer 102 and/or the glass cladding layers 104a, 104b. A devitrified phase may form in the intermixed composition at the temperature corresponding to the viscosity of the glass core layer 102 and/or the glass cladding layers 104a, 104b at their forming temperatures. Typical viscosity of glass at a fusion drawn forming temperature may be from about 35,000 P to about 300,000 P.

Glass compositions for the glass core layer 102 and the glass cladding layers 104a, 104b can be chosen to allow for the intermixed composition to have a higher liquidus temperature than the glass core layer 102 and the glass cladding layers 104a, 104b. For example, the mixture of the glass compositions of the glass core layer 102 and the glass cladding layers 104a, 104b may have a higher liquidus temperature than either the glass core layer 102 or the glass cladding layers 104a, 104b when particular glass compositions are selected. In one embodiment, a sodium rich glass and an alumina rich glass are utilized as the glass core layer 102 and the glass cladding layers 104a, 104b, respectively, or vice versa. A glass layer comprising a higher concentration of a particular component than another glass layer can be considered “rich” in that particular component. Thus, the term “rich” is a relative term that depends on the concentration of the particular component in different glass layers. In another embodiment, a lithium rich glass and a sodium rich glass are utilized as the glass core layer 102 and the glass cladding layers 104a, 104b, respectively, or vice versa. In another embodiment, a lithium rich glass and an alumina rich glass are utilized as the glass core layer 102 and the glass cladding layers 104a, 104b, respectively, or vice versa. In another embodiment, a boron rich glass and an alumina rich glass are utilized as the glass core layer 102 and the glass cladding layers 104a, 104b, respectively, or vice versa. However, it should be understood that many combinations of glass compositions may result in increased liquidus temperature, and any suitable combination of glass compositions is contemplated herein.

In another embodiment, the laminated glass article 100 may comprise zircon and/or zirconia crystals at the lamination interface, which may be caused by increased temperatures of the molten glass cladding compositions 206 when contacted with the upper isopipe 202. Generally, relatively high temperatures for a particular glass composition may lead to zircon breakdown, where zircon from the isopipe migrates into the molten glass composition as zircon and/or zirconia. To create the zircon or zirconia crystals, a glass with a low zircon break down temperature may be utilized at normal processing temperatures, or relatively high processing temperatures may be utilized for a glass composition with a relatively high zircon break down temperature.

An isopipe used in the fusion process is subjected to high temperatures and substantial mechanical loads as molten glass flows into its trough and over its outer surfaces. To be able to withstand these demanding conditions, the isopipe is typically and preferably made from an isostatically pressed block of a refractory material (hence the name “iso-pipe”). In particular, the isopipe may be made from an isostatically pressed zircon refractory, i.e., a refractory composed primarily of ZrO₂ and SiO₂. For example, the isopipe can be made of a zircon refractory in which ZrO₂ and SiO₂ together comprise at least 95 wt. % of the material, with the theoretical composition of the material being ZrO₂. SiO₂ or, equivalently, ZrSiO₄.

Sometimes, zircon crystal inclusions are formed in the glass, which migrate from the isopipe to the glass. Presence of zircon crystal inclusions (sometimes referred to as secondary zircon crystals) in the glass may be a result of the glass' passage into and over the zircon isopipe used in the manufacturing process.

Without being bound by theory, zircon which results in the zircon crystals which are found in the finished glass sheets has its origin at the upper portions of the zircon isopipe. In particular, these defects ultimately arise as a result of zirconia (i.e., ZrO₂ and/or Zr⁺⁴+2O²) dissolving into the molten glass at the temperatures and viscosities that exist in the isopipe's trough and along the upper walls (weirs) on the outside of the isopipe. The temperature of the glass is higher and its viscosity is lower at these portions of the isopipe as compared to the isopipe's lower portions since, as the glass travels down the isopipe, it cools and becomes more viscous.

The solubility and diffusivity of zirconia in molten glass is a function of the glass temperature and viscosity (i.e., as the temperature of the glass decreases and the viscosity increases, less zirconia can be held in solution and the rate of diffusion decreases). As the glass nears the bottom (root) of the isopipe, such as where the molten glass cladding composition 206 contacts the molten glass core composition 208, it may become supersaturated with zirconia. As a result, zircon crystals (i.e., secondary zircon crystals) may nucleate and grow at the interface of the glass core layer 102 and the glass cladding layers 104a, 104b.

It should be appreciated that more than one type of light-scattering component may be utilized in the same laminated glass article. For example, particles may be inserted in to the laminated glass article and blistering may occur during processing, forming gas pockets and solid particles to scatter light propagating through the interface of the laminated glass article.

Although the glass articles are described herein with reference to laminated glass articles comprising a plurality of glass layers, other embodiments are included in this disclosure. In other embodiments, a single layer glass article (e.g., a glass sheet) comprises a light scattering component as described herein. In such embodiments, the light scattering component can be disposed at an outer surface of the single layer glass article. For example, particles can be deposited on the outer surface of the single layer glass article during forming in the same manner described herein for depositing particles on a molten glass core composition or a molten glass cladding composition. Also for example, gas pockets can be formed on the outer surface of the single layer glass article in some of the same manners described herein for forming gas pockets at an interface between a molten glass core composition and a molten glass cladding composition (e.g., applying an electrical potential, reducing or eliminating fining agents, and/or changing an atmosphere surrounding the glass article). Also for example, crystals can be formed on the outer surface of the single layer glass article in some of the same manners described herein for forming crystals at an interface between a molten glass core composition and a molten glass cladding composition (e.g., promoting zircon breakdown). A single layer glass article can be formed, for example, using a fusion forming process similar to the process described herein with reference to FIG. 3 in which the upper overflow distributor is omitted.

In various embodiments, the glass articles described herein can be incorporated into vehicles such as automobiles, boats, and airplanes (e.g., glazing such as windshields, windows or sidelites, mirrors, pillars, side panels of a door, headrests, dashboards, consoles, or seats of the vehicle, or any portions thereof), architectural fixtures or structures (e.g., internal or external walls of building, and flooring), appliances (e.g., a refrigerator, an oven, a stove, a washer, a dryer, or another appliance), consumer electronics (e.g., televisions, laptops, computer monitors, and handheld electronics such as mobile phones, tablets, and music players), furniture, information kiosks, retail kiosks, and the like. For example, the glass articles described herein can be used in display and/or touch panel applications, whereby the glass article can enable a display and/or touch panel with desired attributes of the glass article such as light scattering, mechanical strength, etc. In some embodiments, such displays can comprise projection displays. For example, the glass article comprises light scattering features for displaying an image projected thereon.

In some embodiments, a display comprising a glass article described herein is at least partially transparent to visible light. Ambient light (e.g., sunlight) can make the display image difficult or impossible to see when projected on such a display. In some embodiments, the display, or portion thereof on which the display image is projected can include a darkening material such as, for example, an inorganic or organic photochromic or electrochromic material, a suspended particle device, and/or a polymer dispersed liquid crystal. Thus, the transparency of the display can be adjusted to increase the contrast of the display image. For example, the transparency of the display can be reduced in bright sunlight by darkening the display to increase the contrast of the display image. The adjustment can be controlled automatically (e.g., in response to exposure of the display surface to a particular wavelength of light, such as ultraviolet light, or in response to a signal generated by a light detector, such as a photoeye) or manually (e.g., by a viewer).

The glass articles described herein can be used for a variety of applications including, for example, for cover glass or glass backplane applications in consumer or commercial electronic devices including, for example, LCD, LED, microLED, OLED, and quantum dot displays, computer monitors, and automated teller machines (ATMs); for touch screen or touch sensor applications, for portable electronic devices including, for example, mobile telephones, personal media players, and tablet computers; for integrated circuit applications including, for example, semiconductor wafers; for photovoltaic applications; for architectural glass applications; for automotive or vehicular glass applications including, for example, glazing and displays; for commercial or household appliance applications; for lighting or signage (e.g., static or dynamic signage) applications; or for transportation applications including, for example, rail and aerospace applications.

### Example

The embodiments described herein will be further clarified by the following example. A laminated glass sample was formed from a first glass with a composition (C1) and a second glass with a composition (C2) shown in Table 1. Composition C1 had a relatively high proportion of K₂O and composition C2 had a relatively high proportion of Al₂O₃.

TABLE 1

| Mol % | C1 | C2 |
|---|---|---|
| SiO2 | 71.16 | 65.07 |
| Al2O3 | 3.22 | 9.27 |
| B2O3 | 1.44 | 8.04 |
| MgO | 6.11 | 5.35 |
| CaO | 5.36 | 5.34 |
| SrO | 1.74 | 2.11 |
| K2O | 10.90 | 4.75 |
| SnO2 | 0.07 | 0.07 |

To produce the laminated glass sample, crucible melts were made of both compositions (standard batch materials, melted at 1600° C. overnight). These compositions were chosen so that C1 was a high K₂O glass and C2 was a high Al₂O₃ glass. Thereby, if potassium diffused out of the first glass and into the second glass, leucite would be stabilized as a liquidus phase and would cause a rapid increase in the liquidus temperature. FIG. 5 is a graphical representation of the liquidus temperature of the mixture of the first glass and second glass as a function of the fraction of the second glass in the mixture. A “liquidus dome” forms with peak liquidus temperatures for mixtures of C1 and C2 at a ratio of about 6:4.

After melting overnight, half the crucible of C1 was poured onto a steel block, an amount of C2 was poured on top of the still molten C1, and then the rest of the crucible of C1 was poured over the top of the C1 and C2 stack, making a sandwich of C2 surrounded on all sides by C1 which was then annealed overnight at 660° C. (near the annealing point of both glasses). The sandwich was then placed in a furnace and held overnight at 1050° C., a temperature above the liquidus temperature of either glass C1 or glass C2 but below the expected liquidus temperature of any intermediate glass formed from interdiffusion during the forming process. The interface of C1 and C2 crystallized while the bulk glass of C1 and C2 remained amorphous and transparent.

It should be understood that while the laminated glass articles comprising light-scattering members have been described in the context of image viewing in some embodiments herein, the laminated glass articles comprising light-scattering members may be utilized in a wide variety of applications and are not limited to use in image displays.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

What is claimed is:

1. A light-scattering laminated glass article comprising:
a first glass layer comprising a first glass composition;
a second glass layer comprising a second glass composition and fused to the first glass layer; and
a light-scattering component disposed at an interface of the first glass layer and the second glass layer, the light-scattering component comprising a different composition or material phase than the first glass layer and the second glass layer.

2. The light-scattering laminated glass article of claim 1, wherein the light-scattering component comprises a plurality of light-scattering members.

3. The light-scattering laminated glass article of claim 2, wherein the light-scattering members have an average maximum dimension of about 100 nm to about 1 micron.

4. The light-scattering laminated glass article of claim 2, wherein at least some of the light-scattering members have a maximum dimension of about 100 nm to about 1 micron.

5. The light-scattering laminated glass article of claim 2, wherein at least some of the light-scattering members comprise solid particles.

6. The light-scattering laminated glass article of claim 5, wherein the light-scattering particles comprise silicon carbide, zirconia, alumina, silica, titania, or a combination thereof.

7. The light-scattering laminated glass article of claim 5, wherein the light-scattering particles have a melting point of at least about 1250° C.

8. The light-scattering laminated glass article of claim 2, wherein at least some of the light-scattering members comprise gas pockets.

9. The light-scattering laminated glass article of claim 2, wherein at least some of the light-scattering members comprise zircon crystals, zirconia crystals, or combinations thereof.

10. The light-scattering laminated glass article of claim 1, wherein the light-scattering component comprises one or more crystalline, semi-crystalline, or phase separated bodies.

11. The light-scattering laminated glass article of claim 10, wherein at least some of the light-scattering members comprise a mixture of the first glass composition and the second glass composition.

12. The light-scattering laminated glass article of claim 1, wherein the light-scattering component has a different refractive index than the first glass layer and the second glass layer.

13. A method for forming a light-scattering laminated glass article, the method comprising:
flowing a molten first glass composition;
flowing a molten second glass composition;
depositing a plurality of light-scattering particles onto a surface of the molten first glass composition or a surface of the molten second glass composition; and
contacting the molten first glass composition with the molten second glass composition to form an interface between the molten first glass composition and the molten second glass composition, wherein the plurality of light-scattering particles are located at the interface between the molten first glass composition and the molten second glass composition.

14. The method of claim 13, wherein the light-scattering particles have an average maximum dimension of about 100 nm to about 1 micron.

15. The method of claim 13, wherein at least some of the light-scattering particles have a maximum dimension of about 100 nm to about 1 micron.

16. (canceled)

17. The method of claim 13, wherein the light-scattering particles comprise silicon carbide, zirconia, alumina, silica, titania, or a combination thereof.

18. The method of claim 13, wherein the light-scattering particles have a melting point of at least about 1250° C.

19. A method for forming a light-scattering laminated glass article, the method comprising:
flowing a molten first glass composition;
flowing a molten second glass composition;
contacting the molten first glass composition with the molten second glass composition to form an interface between the molten first glass composition and the molten second glass composition;
producing a plurality of light-scattering gas pockets at the interface between the molten first glass composition and the molten second glass composition.

20. The method of claim 19, wherein the gas pockets form by contact between the molten first glass composition and the molten second glass composition.

21-24. (canceled)

25. The method of claim 13,
wherein the plurality of light-scattering particles comprise one or more crystalline, semi-crystalline, or phase separated bodies positioned at the interface between the molten first glass composition and the molten second glass composition.

26-42. (canceled)
